(19) United States
(12) Patent Application Publication
(10) Pub. No.: US 2017/0083652 A1
(43) Pub. Date: Mar. 23, 2017

(54) SAVING AND RESTORING AN EMULATION ENVIRONMENT

(71) Applicant: Synopsys, Inc., Mountain View, CA (US)

(72) Inventors: Ludovic Marc Larzul, Folsom, CA (US); Frederic Dumoulin, Magny-les-Hameaux (FR)

(21) Appl. No.: 14/858,950

(22) Filed: Sep. 18, 2015

(51) Int. Cl. G06F 17/50; G06F 9/455

(52) U.S. Cl. CPC G06F 17/5045; G06F 9/45533

(57) ABSTRACT

An emulator configured to emulate a DUT is connected to a client device. The client device includes a virtual machine that executes emulation processes against the emulated DUT. When a request is received to save the current state of the emulation environment, the virtual machine stops the execution of the emulation processes and transmits a request to the emulator for the emulator to stop the emulation of the DUT. The virtual machine transmits instructions to the emulator for the emulator to save its current state. The emulator provides to the client device emulator files that describe the current state of the components of the emulator. The emulator files are stored. The operating system of the virtual machine also creates virtual machine files that describe the current state of the virtual machine and stores the virtual machine files in association with the emulator files.

### BACKGROUND

1. Field of Art

The disclosure generally relates to the emulation of designs, and more specifically to saving and restoring the software and hardware states of an emulation.

2. Description of the Related Art

Emulators have been developed to assist circuit designers in designing and debugging highly complex integrated circuit designs (for example, a system on a chip (SOC)). An emulator includes multiple field programmable gate arrays (FPGAs) or specific programmable emulation components that together can imitate the operations of a design under test (DUT). By using an emulator to imitate the operations of a DUT, designers can verify whether a DUT complies with various design requirements prior to fabrication.

As part of testing an emulated DUT, it is typical to run software against the emulated DUT to see if the DUT correctly runs the software. For example, the DUT may be a processor and it may be desirable to test the processor to see if it can correctly load an operating system. A computer system is typically connected to the emulator and runs software processes in collaboration with the emulated DUT.

The execution of software processes with an emulated DUT may take a few hours or days. During the execution of the software processes it may be desirable to stop the emulation, for example, to execute higher priority processes with the same or another DUT. However, executing the higher priority processes results in making changes to the emulation environment (e.g., changes to the states of the emulator and the computer system). In order to be able to resume the emulation environment later on for verification of the DUT, the DUT state and the software under execution must be saved before the emulation environment is changed. As the environment may be composed of components of various origins, various running processes, communications and relations between processes and/or storage devices, and so forth, restoring the environment after the higher priority processes are executed is impossible. Therefore, it becomes necessary to start the running of the software processes from the start which is costly in terms of time and resources.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 is a block diagram of an emulation environment, according to one embodiment.

FIG. 2 is a block diagram illustrating a virtual machine used for emulation, according to one embodiment.

FIG. 3 is a flow chart illustrating saving an emulation environment, according to one embodiment.

FIG. 4 is a flow chart illustrating restoring an emulation environment, according to one embodiment.

FIG. 5 illustrates one embodiment of components of an example machine able to read instructions from a machine-readable medium and execute them in a processor, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein.

Reference will now be made to several embodiments, examples of which are illustrated in the accompanying figures. The figures use like reference numerals to identify like elements. A letter after a reference numeral, such as “110A,” indicates that the text refers specifically to the element having that particular reference numeral. A reference numeral in the text without a following letter, such as “110,” refers to any or all of the elements in the figures bearing that reference numeral.

### Overview

A disclosed system (and method and computer program product) are described for saving and restoring a full emulation environment. An emulator configured to emulate a DUT is connected to a client device. The client device includes a virtual machine that executes emulation processes against the emulated DUT. During the execution of the emulation processes a user can request to save a current state of emulation environment with the emulator.

When a request is received to save the current state of the emulation environment, the virtual machine stops the execution of the emulation processes and transmits a request to the emulator for the emulator to stop the emulation of the DUT. The virtual machine transmits instructions to the emulator for the emulator to save its current state. The emulator provides to the client device emulator files that describe the current state of the components of the emulator. The emulator files are stored. The virtual machine also instructs the operating system of the client device to save the current state of the virtual machine. The operating system creates virtual machine files that describe the current state of the virtual machine and stores the virtual machine files in association with the emulator files. The emulator files and the virtual machine files describe the saved emulation environment.

If a request is made to restore the emulation environment, a virtual machine is restored on the client device to the saved state described by the virtual machine files. Once the restored virtual machine is granted access to the emulator, the virtual machine transmits the emulator files to the emulator and the emulator restores its components to the state described by the emulator files. The emulation environment can then be executed from the saved state.

### Overview Emulation Environment

Figure (FIG. 1 is a block diagram illustrating an emulation environment 100, according to one embodiment. The emulation environment 100 includes an emulator 102, a client device 104, and an environment database 106 connected to a network 108. In some embodiments, the emulator 102 is not connected to the network 108. Although the illustrated environment 100 includes only a select number of each entity, other embodiments can include more of each entity (e.g., additional client devices 104).

The network 108 represents the communication pathways between the entities connected to the network 108. In one embodiment, the network 108 is the Internet and uses standard communication technologies and/or protocols. The network 108 can also utilize dedicated, custom, or private communications links that are not necessarily part of the Internet. The network 108 may comprise any combination of local area and/or wide area networks, using both wired and wireless communication systems. In one embodiment, information exchanged via the network 108 is cryptographically encrypted.

The emulator 102 is a hardware system that emulates a DUT. A DUT (also referred to as an “electronic DUT”) comprises one or more circuit designs that are to be emulated by the emulator 102. In one embodiment, a DUT is a system on a chip (SOC). The emulator 102 includes multiple reconfigurable logic blocks that can be configured to emulate a DUT. In one embodiment, the reconfigurable logic blocks are field-programmable gate arrays (FPGAs). To emulate a DUT FPGAs of the emulator 102 are each configured to emulate a partition of the DUT. In other embodiments, the logic blocks included in the emulator are application-specific integrated circuits (ASICs) customized for a specific use. The emulator 102 may be referred to herein as an ASIC emulator which refers to an emulator 102 that includes FPGAs or specific ASICs.

The emulator 102 is connected to the client device 104 via connection 118. The emulator 102 and the client device 104 exchange information via the connection 118. In one embodiment, the connection 118 is a PCI Express connection. In other embodiment, the connection is an Ethernet, HDMI, or USB connection. In one embodiment, the connection 118 is a wireless connection. In another embodiment, the emulator 102 and the client device 104 exchange information via the network 108.

During emulation of the DUT, the emulator 102 receives from the client device 104 information and instructions for the emulation of the DUT. Instructions received by the emulator 102 may be to run or stop the emulation of the DUT. The instructions received may also be to save the current state of the emulator 102. When the emulator 102 receives instructions to save the current state, the emulator 102 creates one or more emulator files that describe the current state of the emulator components (files describe the hardware state of the emulator 102). The emulator files, for example, may describe the configuration of logic elements, content of memories, configuration of configurable components, the state of the emulation control, etc. The emulator 102 transmits the created files to the client device 104.

The emulator 102 may also receive emulator files from the client device 104 and a request for the emulator 102 to restore itself to the state described by the emulator files. The emulator 102 restores its components based on the request to the state described by the emulator files.

The client device 104 is a computer system that communicates with the emulator 102 for the emulation of a DUT. The client device 104 includes an operating system 110, a connection driver 112, an access module 114, and one or more virtual machines 116.

The operating system 110 manages the hardware and software resource of the client device 104. The operating system 110 provides applications of the client device 104 with access to services through application program interfaces (APIs). Additionally, the operating system 110 provides a user interface that allows users to interact with the client device 104.

The connection driver 112 allows the client device 104 to control and exchange information with the emulator 102 through the connection 118. The connection driver 112 processes information exchanged with the emulator 102. For example, if an entity (e.g., a module) executing on the client device 104 requests to send information to the emulator 102, the connection driver 112 converts the information into a format that can be processed by the emulator 102. Similarly, when the client device 104 receives information from the emulator 102, the connection driver 112 processes the information prior to forwarding it to the intended recipient on the client device 104. In one embodiment, the connection driver 112 contains a PCI Express driver. In other embodiments, the connection driver 112 contains an Ethernet, HDMI, or USB driver.

The access module 114 manages access to emulator 102 by virtual machines 116. In one embodiment, the access module 114 only grants one virtual machine 116 at a time access to the emulator 102 through the connection driver 112. A virtual machine 116 that is granted access to the emulator 102 has full control of the connection driver 112.

When a virtual machine 116 requests access to the emulator 102, the access module 114 determines whether another virtual machine 116 currently has access to the emulator 102. In one embodiment, if no other virtual machine 116 currently has access to the emulator 102, the access module 114 grants the virtual machine's request. However, if another virtual machine 116 currently has access, the access module 114 adds the request to a queue. In one embodiment, requests in the queue are processed based on when they were added to the queue, for example, using a first in, first out (FIFO) method. In one embodiment, access requests received by the access module 114 have different priorities. The priorities are used by the access module 114 to determine which requests from the queue to process first.

A virtual machine 116 is an isolated operating environment running on the client device 104. The virtual machine 116 functions as if it were a separate client device 104. Multiple virtual machines 116 can executed on the client device 104 completely separate from each other and a different emulation environment can be executed on each virtual machine 116 (i.e., each virtual machine 116 can execute different emulation processes). For example, one test bench can be executed on one virtual machine 116 and another test bench can be executed on another virtual machine 116. Client device 104 resources are allocated to each virtual machine 116 as needed.

When a virtual machine 116 receives a request to execute emulation processes against a DUT emulated by the emulator 102, the virtual machine 116 requests access to the emulator 102 from the access module 114. Once the access module 114 grants the virtual machine 116 access to the emulator 102, the virtual machine 116 executes the emulated DUT with the emulation processes by exchanging information with the emulator 102 via the connection driver 112.

As the emulation processes are being executed, the virtual machine 116 may receive a request (e.g., from a user, a process, or a job scheduler) to save the current state of the emulation environment created by the virtual machine 116. The request may be made, for example, by a user in order to execute different emulation processes against the same or a different DUT using another virtual machine 116. However, by saving the state of the emulation environment, the user can later continue executing the emulation processes from where they left off using the saved state. A user may also request to save the current state of the emulation environment in order to continue executing the emulation processes on other client devices 104 or emulators 102 without having to start from the beginning of the execution. For example, this may be necessary if the current client device 104 or emulator 102 need to be shut down.

When the virtual machine 116 receives a request to save the state of the emulation environment, the virtual machine 116 initiates saving the state of the emulator 102 (the hardware state) and saving the state of the virtual machine 116 (the software state). Saving both is necessary in order to be able to completely restore the emulation environment.

Based on the request the virtual machine 116 sends an instruction to the emulator 102 via the connection driver 112 to stop the emulation of the DUT. After the emulation has been stopped, the virtual machine 116 (or the access module 114 or the connection driver 112), instructs the emulator 102 to create one or more emulator files that describe the current state of the emulator 102. The client device 104 receives the emulator files from the emulator 102 and the files are stored in the environment database 106. The virtual machine 116 then instructs the operating system 110 to save the current state of the virtual machine 116. Based on the instruction from the virtual machine 116, the operating system 110 creates virtual machine files describing the current state of the virtual machine 116. The operating system 110 stores the virtual machine files in the environment database 106 with the emulator files. The virtual machine files and the emulator files collectively describe the emulation environment. In one embodiment, the environment database 106 is a hard disk located on the client device 104 or a hard disk accessible through the network 108.

After the files have been stored, the virtual machine 116, for example, can be terminated by a user and the emulator 102 can be run using another virtual machine 116 or client device 104. As another example, the virtual machine 116 may continue executing the emulation processes with the emulator 102 from where the emulation was stopped. The stored virtual machine and emulator files can later be used to revert back to the emulation environment described by the files. This is beneficial for executing different tests on the emulated DUT where each test is started with the same saved state.

A user can also request to restore a saved emulation environment on the virtual machine 116. When such a request is made, the operating system 110 identifies the virtual machine files associated with the emulation environment that are stored in the environment database 106. The operating system 110 rebuilds a virtual machine 116 to the state described by the virtual machine files.

After the virtual machine 116 has been rebuilt, the virtual machine 116 then requests from the access module 114 access to the emulator 102 through connection driver 112. When the access module 114 grants the virtual machine 116 access to the emulator 102, the virtual machine 116 requests that the connection driver 112 transmit to the emulator 102 the emulator files associated with the emulation environment being restored. The virtual machine 116 also instructs the emulator 102 to restore itself to the state described by the emulator files. The virtual machine 116 receives confirmation, from the emulator 102 via the connection driver 112, once the emulator 102 has been set to the state of the emulator files. The virtual machine 116 can then execute the emulation of the DUT from point where the emulation environment was saved.

As described above, the environment database 106 stores emulator and virtual machine files that describe emulation environments saved by virtual machines 116. In one embodiment, instead of the environment database 106 being separate from the client device 104, the environment database 106 is part of the client device 104.

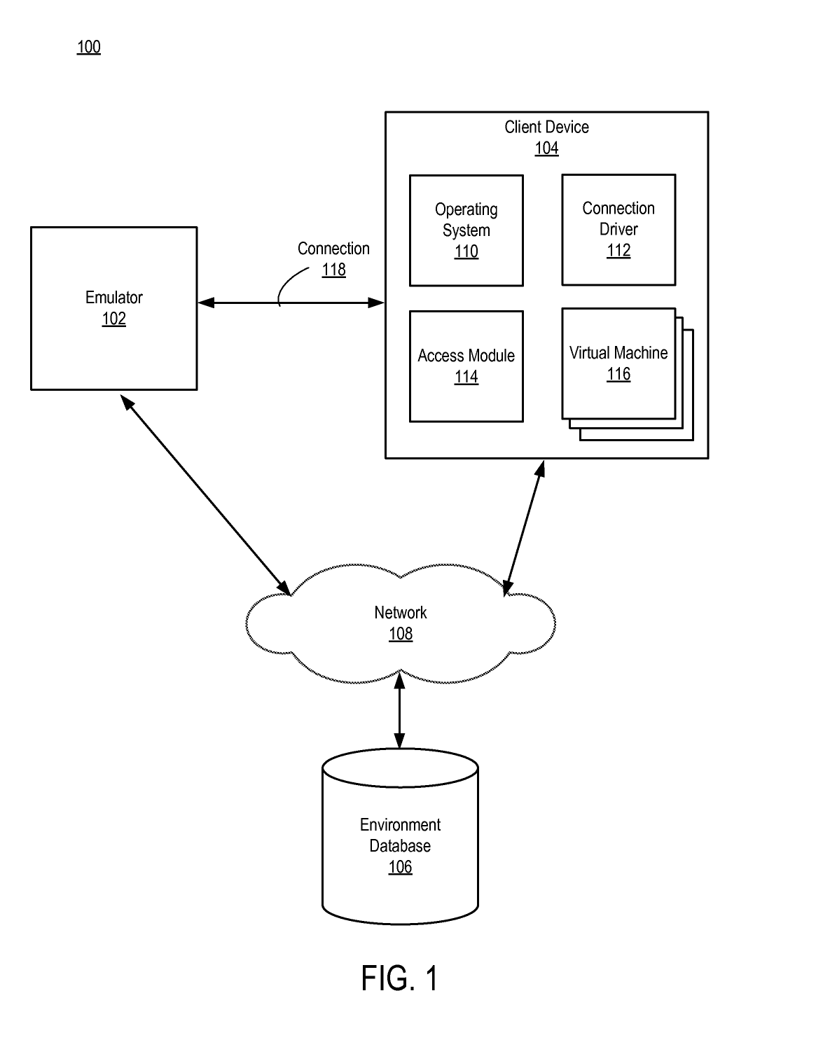

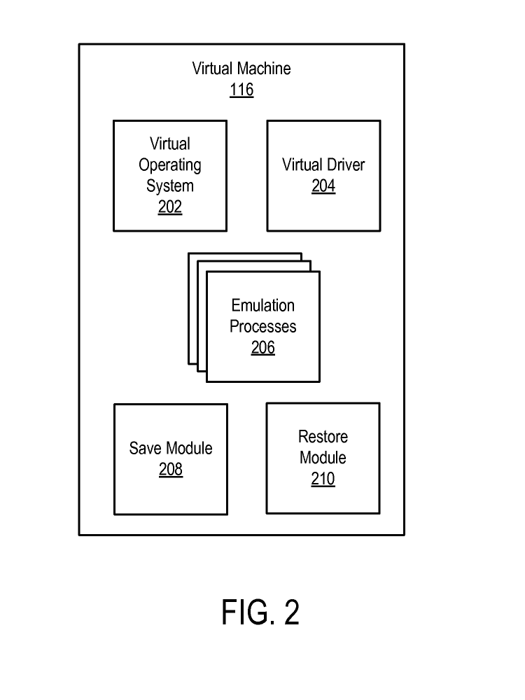

FIG. 2 is a block diagram illustrating a virtual machine 116 in more detail, according to one embodiment. The virtual machine 116 includes a virtual operating system 202, a virtual driver 204, emulation processes 206, a save module 208, and a restore module 210.

The virtual operating system 202 and virtual driver 204 have similar functionality to the operating system 110 and the connection driver 112 respectively but limited to the environment of the virtual machine 116. The virtual operating system 202 manages the resources of the virtual machine 116 and provides applications executing on the virtual machine 116 with access to different services. The virtual driver 204 allows the virtual machine 116 to control and communicate with the emulator 102. For the virtual machine 116 to exchange information with the emulator 102 the virtual driver 204 communicates with the connection driver 112. In one embodiment, any information exchanged between the emulator 102 and the virtual machine 116 passes through the virtual driver 204 and the connection driver 112.

The emulation processes 206 are processes executed by the virtual machine 116 against the DUT emulated by the emulator 102. When the emulation processes 206 are executed they may provide information (e.g., inputs) to the emulator 102 and perform different functions based on information received from the emulator 102. For example, based on information received from the emulator 102, an emulation process 206 may determine whether the DUT satisfies certain criteria. An emulation process 206 can also control the emulation of the DUT by, for example, running or stopping the emulation. In one embodiment, an emulation process 206 is a test bench. In another embodiment, an emulation process 206 is a simulator.

The save module 208 processes requests to save an emulation environment created by the virtual machine 116 with the emulator 102. A request to save an emulation environment may be made, for example, by a user of the virtual machine 116 or by an emulation process 206 executing on the virtual machine 116. Further, a request to save an emulation environment may be made while the emulation processes 206 are executing against the DUT emulated by the emulator 102. In one embodiment, the save module 208 is part of an emulation process 206. In one embodiment, the save module 208 is part of an emulation process 206.

When the save module 208 receives a request to save an emulation environment, the save module 208 stops the emulation processes 206 executing on the virtual machine 116 and transmits a request to emulator 102 through the virtual driver 204 for the emulator 102 to stop the emulation. The save module 208 instructs the virtual driver 204 and the connection driver 112 to flush out any data being exchanged between the virtual machine 116 and the emulator 102. Based on the instruction the virtual driver 204 and the connection driver 112 will transfer data stored in temporary storage locations to the intended destinations (e.g., move the data to permanent memory). For example, data being transmitted from the virtual machine 116 may be stored in buffers by the virtual driver 204 and/or the connection driver 112 while in transit. Based on the instruction from the save module 208 the data is transferred from the buffers to the emulator 102. Similarly data received from the emulator 102 is pushed to the virtual machine 116.

The save module 208 transmits an instruction to the emulator 102 via the virtual driver 204 for the emulator 102 to save the current state of the emulator 102. Based on the instructions the emulator 102 creates emulator files that describe the current state of the emulator 102. In one embodiment, the virtual machine 116 receives the emulator files from the emulator 102 and the save module 208 stores the emulator files in the environment database 106. In another embodiment, the emulator files received by the client device 104 from the emulator 102 are not provided to the virtual machine 116. Instead a process (e.g., the access module 114 or the connection driver 112) executing of the client device 104 and which is not part of the virtual machine 116 stores the emulator files in the environment database 106.

Once the emulator files have been saved, the access module 114 rescinds the virtual machine's access to the emulator 102 via the connection driver 112 and the save module 208 transmits a request to the operating system 110 of the client device 104 for the operating system to create virtual machine files that describe the current state of the virtual machine 116. The operating system 110 creates the created files based on the request and stores the virtual machine files in the environment database 106 in association with the stored emulator files. The virtual machine files may describe, for example, the state of each disk of the virtual machine 116, the contents of the virtual machine's memory, settings of the virtual machine 116, etc.

The restore module 210 communicates with the emulator 102 through the virtual driver 204 and the connection driver 112 to restore a saved emulation environment. When a request to restore a saved emulation environment is made, the virtual machine 116 is restored to the state described by the virtual machine files associated with the saved emulation environment (software state is restored). However, in order to fully restore the emulation environment, the emulator 102 has to be set to the hardware state associated with the saved emulator environment. In order to set the emulator 102, the restore module 210 identifies the emulator files stored in the environment database 106 that are associated with the emulation environment. The restore module 210 also requests from the access module 114 access to the emulator 102.

Once the access module 114 grants the virtual machine 116 access to the emulator 102, the restore module 210 transmits the identified emulator files to the emulator 102 via the virtual driver 204 and instructs the emulator 102 to restore itself to the state described by the emulator files. Once the emulator 102 has been restored to the saved state, the restore module 210 receives an indication from the emulator 102 that it has been restored. Emulation processes 206 can then be executed from the saved state.

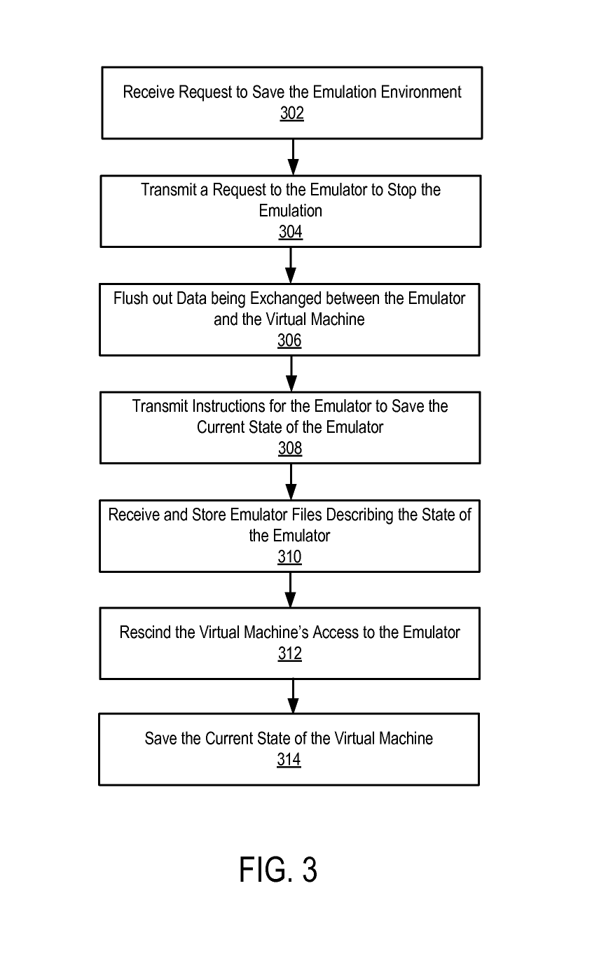

FIG. 3 is a flow chart illustrating saving an emulation environment, according to one embodiment. Other embodiments can perform the steps of FIG. 3 in different orders. Moreover, other embodiments can include different and/or additional steps than the ones described here.

Assume for purposes of this example that a virtual machine 116 on the client device 104 currently has access to the emulator 102 and is executing emulation processes against a DUT emulated by the emulator 102. The client device 104 receives 302 a request to save the current emulation environment created by virtual machine 116. The client device 104 transmits 304 a request to the emulator 102 to stop the emulation of the DUT. The client device 104 flushes out 306 data being exchanged (in-transit) between the emulator 102 and the virtual machine 116.

The client device 104 transmits 308 instructions 102 to emulator 102 for the emulator 102 to save the current state of itself. The client device 104 receives and stores 310 emulator files created by the emulator 102 based on the instructions. The emulator files describe the current state of the emulator components. The client device 104 rescinds 312 the virtual machine's access to the emulator 102. The client device 104 creates and saves 314 virtual machine files describing the current state of the virtual machine 116. Collectively the saved emulator and virtual machine files describe the hardware and software state of the emulation environment at the point where the emulation was stopped.

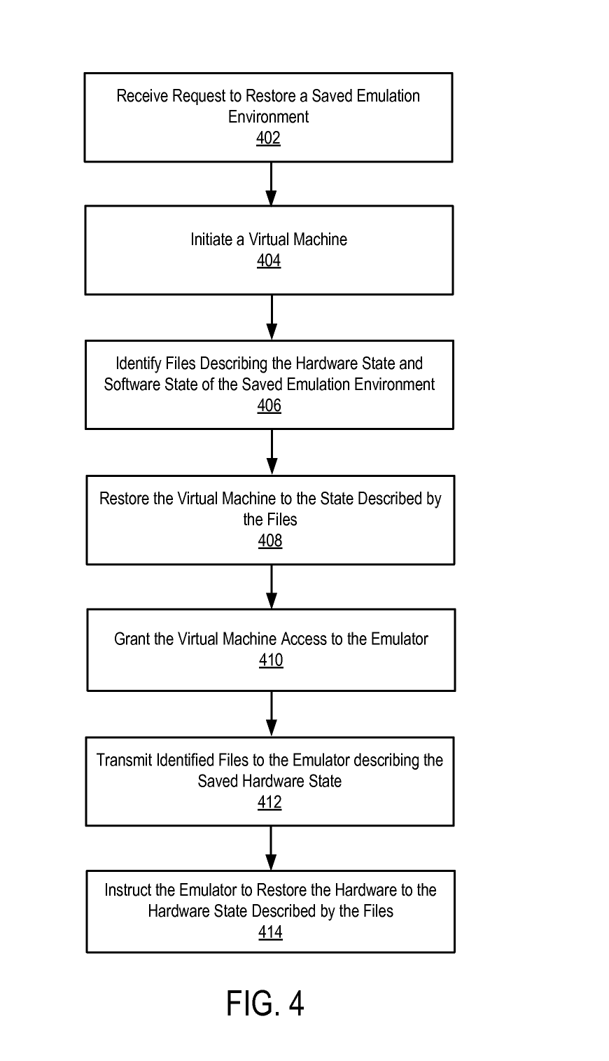

FIG. 4 is a flow chart illustrating restoring an emulation environment, according to one embodiment. Other embodiments can perform the steps of FIG. 4 in different orders. Moreover, other embodiments can include different and/or additional steps than the ones described here.

The client device 104 receives 402 a request to restore a saved emulation environment on a virtual machine 116. The client device 104 initiates 404 a virtual machine 116 and identifies 406 files associated with the emulation environment. Specifically, the client device 104 identifies emulator files that describe the hardware state of the saved emulation environment and virtual machine files that describe the software state of the emulation environment.

The client device 104 restores 408 the virtual machine 116 to state described by the virtual machine files. The client device 104 grants 410 the virtual machine 116 access to the emulator 102 based on an emulator access request initiated by the virtual machine 116. The client device 104 transmits 412 the emulator files to the emulator 102 that describe the hardware state of the emulation environment. The client device 104 instructs 414 the emulator 102 to restore its hardware to the hardware state described by the emulator files. Once the emulator 102 has been restored, the emulation environment can be executed from where it was saved. In one embodiment, steps 410, 412 and 414, are initiated by the restore module 210 on the restored virtual machine 116.

### Computing Machine Architecture

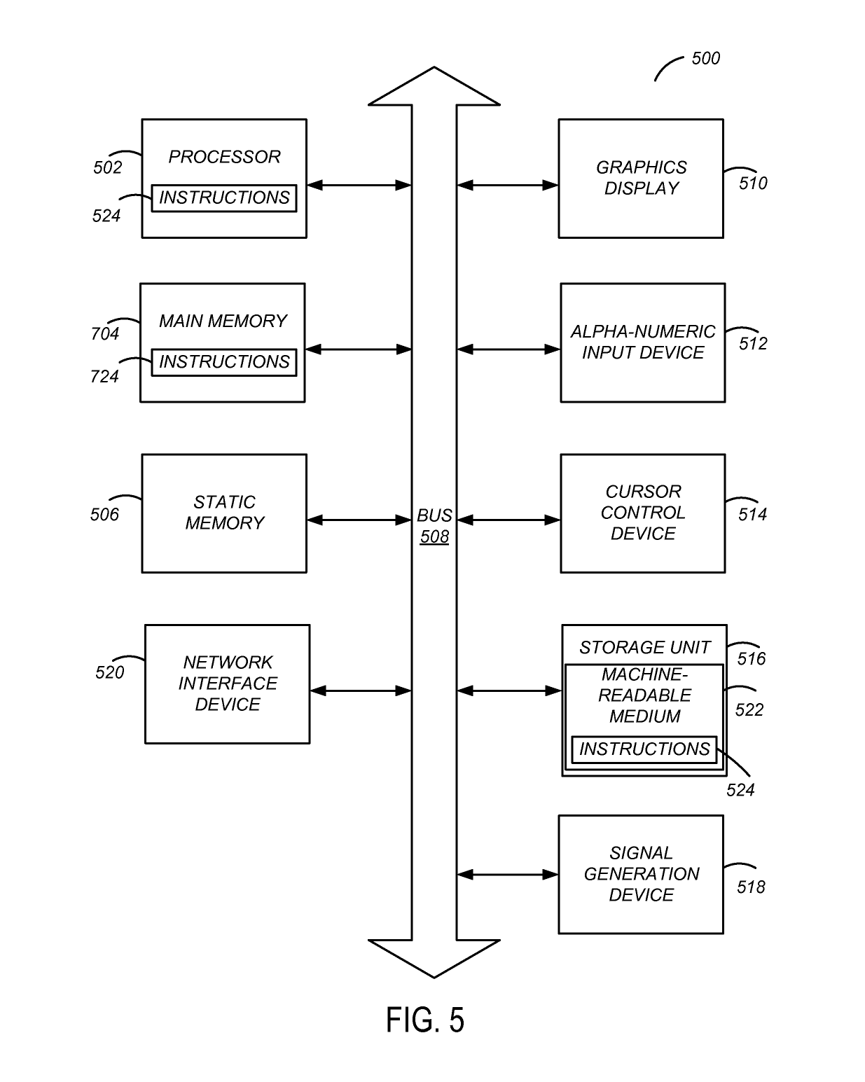

Turning now to FIG. 5, it is a block diagram illustrating components of an example machine able to read instructions from a machine-readable medium and execute them in a processor (or controller). Specifically, FIG. 5 shows a diagrammatic representation of a machine in the example form of a computer system 500 within which instructions 524 (e.g., software or program code) for causing the machine to perform (execute) any one or more of the methodologies described with FIGS. 1-4. The computer system 500 may be used for one or more of the entities (e.g., host system 110, emulator 120) illustrated in the emulation environment 100 of FIG. 1.

The example computer system 500 includes a hardware processor 502 (e.g., a central processing unit (CPU), a graphics processing unit (GPU), a digital signal processor (DSP), one or more ASICs, one or more radio-frequency integrated circuits (RFICs), or any combination of these), a main memory 504, and a static memory 506, which are configured to communicate with each other via a bus 508. The computer system 500 may further include graphics display unit 510 (e.g., a plasma display panel (PDP), a liquid crystal display (LCD), a projector, or a cathode ray tube (CRT)). The computer system 500 may also include alphanumeric input device 512 (e.g., a keyboard), a cursor control device 514 (e.g., a mouse, a trackball, a joystick, a motion sensor, or other pointing instrument), a storage unit 516, a signal generation device 518 (e.g., a speaker), and a network interface device 520, which also are configured to communicate via the bus 508.

The storage unit 516 includes a machine-readable medium 522 which stores instructions 524 (e.g., software) embodying any one or more of the methodologies or functions described herein. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over the network 108 via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but not be limited to, data repositories in the form of solid-state memories, optical media, and magnetic media.

As is known in the art, a computer system 500 can have different and/or other components than those shown in FIG. 5. In addition, the computer system 500 can lack certain illustrated components. For example, a computer system 500 acting as the emulator 120 may include one or more hardware processors 502, multiple storage units 516, a network interface device 520, and multiple configurable logic circuits (as described above with reference to FIG. 1), among other components, but may lack an alphanumeric input device 512 and a cursor control device 514.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIGS. 1-5. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software (or computer program code)) may be driven by cost and time considerations.

The various operations of example methods described herein may be performed, at least partially, by one or more processors, e.g., processor 502, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for efficient event detection of a digital circuit through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A non-transitory computer readable medium storing executable instructions for saving an emulation environment, the instructions to configure a client device to:
run a virtual machine on the client device, the virtual machine executing emulation processes with an emulator emulating an electronic design under test (DUT);
receive a request to save an emulation environment created by the virtual machine with the emulator; and
store information describing a state of components of the emulator and information describing a state of the virtual machine in response to receiving the request.

2. The non-transitory computer readable medium of claim 1, wherein the instructions further configure the client device to:
receive from the virtual machine a request to access the emulator prior to the virtual machine executing the emulation processes;
determine whether to grant the virtual machine access to the emulator; and
grant the virtual machine access to the emulator in response to determining to grant the virtual machine access to the emulator.

3. The non-transitory computer readable medium of claim 2, wherein only a set number of virtual machines are granted access to emulator at a same time.

4. The non-transitory computer readable medium of claim 1, wherein the instructions further configure the client device to:
transmit to the emulator a stop request for the emulator to stop the emulation of the electronic DUT in response receiving the request to save.

5. The non-transitory computer readable medium of claim 1, wherein the instructions further configure the client device to:
transfer data stored in temporary storage locations to intended destinations in response to receiving the request to save, the data being exchanged between the virtual machine and the emulator.

6. The non-transitory computer readable medium of claim 1, wherein the instructions further configure the client device to:
transmit to the emulator instructions to save the state of the components; and
generate information describing the state of the virtual machine;
wherein information describing the state of the components is stored and the information describing the state of the virtual machine is stored.

7. The non-transitory computer readable medium of claim 1, wherein the instructions further configure the client device to:
receive a request to restore the emulation environment;
restore the virtual machine to an equivalent state as described by the stored information; and
instruct the emulator to restore the components to an equivalent state as described by the stored information describing the state of the components.

8. The non-transitory computer readable medium of claim 1, wherein the client device continues to run in response to storing the information.

9. The non-transitory computer readable medium of claim 1, wherein the information describing the state of the components and the information describing the state of the virtual machine is stored on a storage separate from the client device.

10. A non-transitory computer readable medium storing executable instructions for executing a virtual emulation environment, the instructions to configure a client device to:
run a virtual machine on the client device;
grant the virtual machine access to an emulator configured to emulate an electronic design under test (DUT); and
execute an emulation process on the virtual machine with the emulator emulating the electronic DUT.

11. The non-transitory computer readable medium of claim 10, wherein the instructions further configure the client device to:
receive a request to save an emulation environment created by the virtual machine with the emulator;
store information describing a state of components of the emulator and information describing a state of the virtual machine in response to receiving the request; and
close the virtual machine.

12. The non-transitory computer readable medium of claim 11, wherein the instructions further configure the client device to:
receive a request to restore the emulation environment;
restore the virtual machine to an equivalent state as described by the stored information; and
instruct the emulator to restore the components to an equivalent state as described by the stored information describing the state of the components.

13. A non-transitory computer readable medium storing executable instructions for restoring an emulation environment, the instructions to configure a client device to:
receive a request to restore an emulation environment;
restore a virtual machine to an equivalent saved state described by virtual machine information associated with the emulation environment; and
transmit emulator information to an emulator, the emulator information associated with the emulation environment and describing an equivalent of a saved state of components of the emulator, the components restored to the saved state based on the transmitted emulator information.

14. The non-transitory computer readable medium of claim 13, wherein the instructions further configure the client device to:
receive from the virtual machine a request to access the emulator;
determine whether to grant the virtual machine access to the emulator; and
transmit to the emulator the emulator information in response determining to grant the virtual machine access to the emulator.

15. The non-transitory computer readable medium of claim 13, wherein the virtual machine is granted access to the emulator via a connection driver that exchanges information with the emulator through a connection.

16. A method for executing a virtual emulation environment, the method comprising:
running a virtual machine on a client device;
granting the virtual machine access to an emulator configured to emulate an electronic design under test (DUT); and
executing an emulation process on the virtual machine with the emulator emulating the electronic DUT.

17. The method of claim 16, further comprising
receiving a request to save an emulation environment created by the virtual machine with the emulator;
storing information describing a state of components of the emulator and information describing a state of the virtual machine in response to receiving the request; and
closing the virtual machine.

18. The method of claim 17, further comprising:
receiving a request to restore the emulation environment;
restoring the virtual machine to the state described by the stored information; and
instructing the emulator to restore the components to the state described by the stored information describing the state of the components.

19. The method of claim 17, further comprising:
responsive to receiving the request, transmitting to the emulator a stop request for the emulator to stop the emulation of the electronic DUT.

20. A non-transitory computer readable medium storing executable instructions for:
storing virtual machine and emulator files describing a saved state of an emulation environment for emulating an electronic design under test (DUT); and
executing a plurality of tests on the electronic DUT, each of the plurality of tests started with the saved state of the emulation environment based on the stored virtual machine and emulator files.
